(19) United States
(12) Patent Application Publication
(10) Pub. No.: US 2026/0251228 A1
(43) Pub. Date: Aug. 27, 2026

(54) Inline Pump Valve Cartridge

(71) Applicants: Louis P Vickio, JR., Houston, TX (US); Russell Dewayne Reed, Pearland, TX (US)

(72) Inventors: Louis P Vickio, JR., Houston, TX (US); Russell Dewayne Reed, Pearland, TX (US)

(21) Appl. No.: 19/065,120

(22) Filed: Feb. 27, 2025

(51) Int. Cl. F16K 15/02; F04B 53/10

(52) U.S. Cl. CPC F16K 15/025; F04B 53/10; F16K 2200/501

(57) ABSTRACT

In the pumping industry there are many inline valves designed reciprocating pumps that produce flow at high pressures. An example of these pumps are triplex pumps. When the piston is pulled back, it intakes fluid. When the piston is pushed forward it produces flow in a positive displacement manner. This action uses a valving system that seals the intake side from the output side. These valves wear out during the extended use of pumping. As the valve system design is now, it is required to take the valve assembly in and out in stages. This valve change requires special tools. This maintenance event can become an issue in remote locations where these pumps are frequently used. This patent has redesigned the inline valving system into single valve cartridge assembly that will not require special tools. It can be retrieved and installed as one complete assembly.

### REFERENCE TO RELATED PATENTS

U.S. Pat. No. 8,240,634 B2
U.S. Pat. No. 8,221,100 B2
U.S. Pat. No. 6,241,492 B1
U.S. Pat. No. 5,037,276
U.S. Pat. No. 9,188,122 B1
U.S. Pat. No. 4,634,353
U.S. Pat. No. 4,551,077
U.S. Pat. No. 7,172,175 B2

### BACKGROUND OF THE INVENTION

Heretofore most valve assemblies throughout the industry would be removed and installed in pieces. The outer manifold would be removed by unscrewing either many bolts or access nuts, then a “special tool” would be required the remove the valves and mid-section. The tool would be a threaded shaft with a weight to slide hard to the back of the rod to pull the sealed mid-section out. Then needle nose pliers would be needed to retrieve the first spring. Then with needle nose pliers the outlet valve would be removed. The “special tool” with the sliding weight would be threaded into suction valve components and removed with the hammering force. With this action, there is a potential to drop the valve assembly parts into the suction bore which will cause the removal of the entire fluid cylinder to retrieve the lost part. This action would require some form of hoisting as the entire fluid cylinder is heavy. In another occurring event the threads of the special tool might not work in the bottom cap of the typical assembly. Therefore, the special tool will not work, and the entire fluid cylinder will have to be removed as stated above.

Upon re-installation the “special tool” needs to be threaded into the lower half of the valve assembly and hammer it into position with the sliding weight. Then the outlet valve would be installed with needle nose pliers. With the needle nose pliers, the spring must be carefully placed on the outlet valve and must balance there while installing the outlet valve cage. With the “special tool” the outlet valve cage will be installed with a hammering process. If the spring drops the spring would be damaged. Finally, the many bolts or access nuts may be installed

Our invention will allow the entire valve system components to be removed and installed merely by unscrewing and screwing in a complete valve cartridge assembly. The whole assembly is replaced as a cartridge.

### DETAILED DESCRIPTION

FIG. 1 shows the cartridge assembly that includes the valving system. In the inner cap 101 is a spring 102 that aids the return position of the intake valve 103. The intake valve 103 will open during intake and the spring 102 will close the valve during fluid discharge. It also has a flow manifold 104 that will intake fluid from radially positioned holes 111 and outflow fluid through axially placed holes 112. The fluid will then exit to the output side of the pump via the radial holes 113. The output valve 105 will spring 106 closed while the fluid entering through intake valve 103 and open when the fluid is being discharged. The assembly nut 107 is used to thread the cartridge into position. The cartridge will contain three sets of seals. The two inner seals 108 and 109 that will surround the fluid intake cavity allowing separation from the output fluid area. The seals 109 and 110 will surround the fluid output area allowing separation from the input fluid area.

FIG. 2 shows the cartridge inserted in the pump body 211 with both the intake valve 203 and the outlet valve 205 in the intake position. The pump piston 212 is retracked to the final stage of intake. The intake valve 203 is open with the spring 202 compressed and is allowing flow 217 from the intake port 216 via the manifold radial holes 214 to the area 213 via the intake valve 203 and the inner cap 201 holes. The outlet valve 205 is closed with spring 206 extended. Innermost seal 208 and secondary seal 209 separates the input 216 and output 215 areas.

FIG. 3 shows the cartridge inserted in the pump body 310 with the valves in the output configuration. The pump piston 311 is on the final stage of output. The intake valve 303 is in the closed position with the spring 302 extended. Output flow 312 is flowing through the inner cap 301 and through the axial holes in the manifold 304 and with the output valve 305 in the open position and spring 306 compressed. The flow 312 continues through the radial holes of the output side of the manifold 304. The secondary seal 308 and outermost seal 309 contain the fluid so to direct it through the port 312

FIG. 4 shows the flow paths that are simplified to allow a more efficient flow. Input flow 403 is coming in radially to a cavity 404. The congregate of these hole areas are larger that the area that the retracking piston to allow more efficient intake flow. Output flow 402 will flow through the axial holes 406 into area 405 and out the radial holes 407

### BRIEF DESCRIPTION OF THE DRAWINGS

FIG. 1 shows a cartridge assembly in its entirety.

FIG. 2 shows the cartridge installed in the pump system with the input/output valves in the intake position

FIG. 3 shows the cartridge installed in the pump system with the input/output valves in the output position

FIG. 4 shows the newly designed and unique manifold that allows more efficient flow.

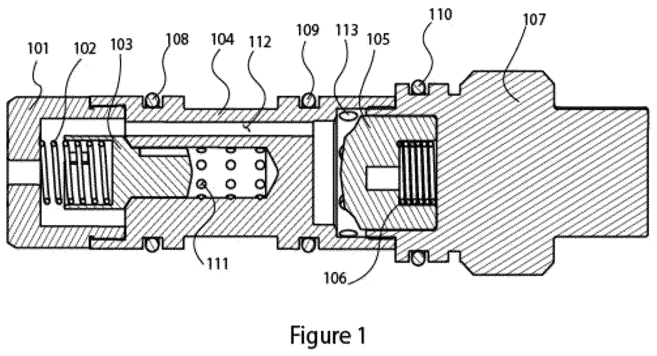

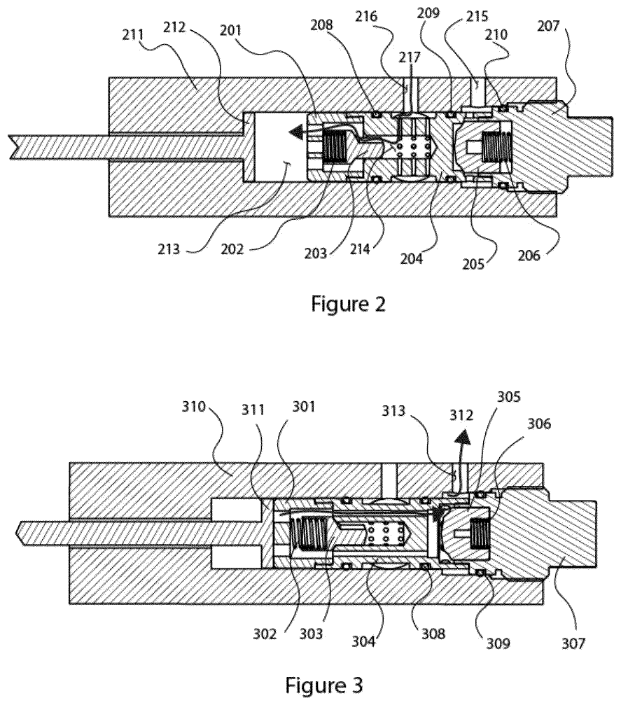

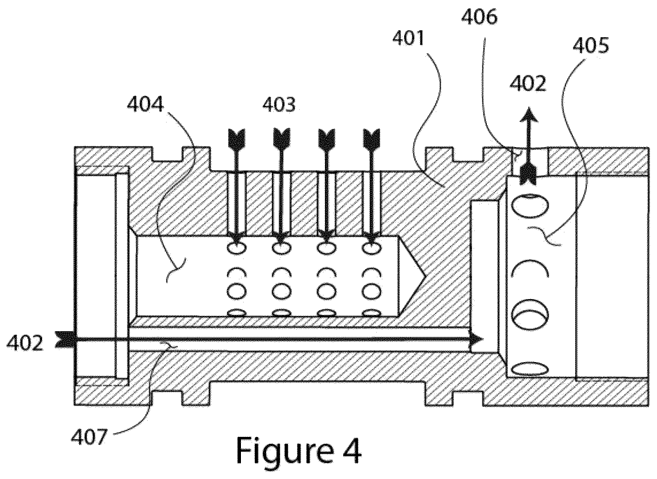

1. The cartridge is a version of a complete valve assembly that may include seals for the segregation of pressures and flows.

2. The cartridge can be removed as a single assembly by unscrewing the assembly from the Cylinder head without specially designed tools.

3. The cartridge can be installed as a single assembly by screwing the assembly in the cylinder head without specially designed tools.

4. The cartridge itself can be disassembled for repair when necessary.

5. The flow paths through the newly designed manifold are simplified to allow a more efficient flow of fluid. The amount of input and output holes have been increased to all less restriction through the manifold. The paths have been made more direct than previous designs.
